(19) United States
(12) Patent Application Publication
(10) Pub. No.: US 2015/0321444 A1
(43) Pub. Date: Nov. 12, 2015

(54) Fiber Composite Component Having Radiation Crosslinked Filler

(71) Applicant: Airbus Defence and Space GmbH, Ottobrunn (DE)

(72) Inventors: Christoph BREU, Rohrdorf (DE); Uwe BEIER, Hoehenkirchen (DE); Christian METZNER, Neubiberg (DE)

(21) Appl. No.: 14/639,420

(22) Filed: Mar. 5, 2015

(30) Foreign Application Priority Data
Mar. 6, 2014 (EP) 14000798.0

(51) Int. Cl. B32B 3/28; B29C 45/17; B32B 5/26; C08J 3/28; C08J 3/24; B29C 47/00; C08J 5/04

(52) U.S. Cl. CPC B32B 3/28; B29C 47/0064; B29C 45/17; C08J 5/04; C08J 3/28; C08J 3/24; B32B 5/26; B29K 2021/00

(57) ABSTRACT

A fiber composite component is produced by first producing a filler for a preform of the fiber composite component from a plastic material, the preform including a textile material. The plastic material of the filler is crosslinked so that plastic molecules of the plastic material are bonded together. The filler is inserted into the preform of the fiber composite component and the filler is bonded to the preform so as to form the fiber composite component.

### CROSS-REFERENCE TO RELATED APPLICATIONS

This application claims priority under 35 U.S.C. §119 to European application 14000798.0, filed Mar. 6, 2014, the entire disclosure of which is herein expressly incorporated by reference.

### FIELD OF THE INVENTION

Exemplary embodiments of the invention relate to a method for producing a fiber composite component and to a use of a radiation crosslinked filler in a fiber composite component. The invention furthermore relates to fiber composite component.

### BACKGROUND OF THIS INVENTION

Cavities may develop, for example, when connecting angular profiled sections to planar structures so as to produce fiber composite components from textile semi-finished products or prepreg materials (which is to say pre-impregnated materials); these cavities should be filled with fiber material for structural mechanics reasons. This can generally be achieved with great complexity by using suitable textile or pre-impregnated filler structures since these fillers should not have a preferred fiber direction.

For example, it is possible when textile reinforcement elements are applied to planar semi-finished products to fill the developing cavities with braided filler structures made of carbon fiber rovings. In general, a precisely fabricated product must be created for every cavity geometry. An exactly fitting shape is normally not ensured, and adjusting a specific fiber content is thus difficult. Moreover, this solution is generally subjected to high tolerances in the production of the filler and the introduction thereof, which can directly impact the component quality.

Another approach is to produce filler structures from prepreg materials. This solution allows fillers to be produced in high quality and with a high degree of freedom in the fiber architecture, but is generally extremely complex.

As is described in DE 10 2006 031432 A2, for example, fillers can also be produced from thermoplastic materials; however, in combination with epoxy-based matrix systems, this can result in scouring, swelling, or also in the formation of cracks in the filler or fiber composite.

### SUMMARY OF THE INVENTION

Exemplary embodiments of the invention are directed to a fiber composite component with improved mechanical properties and that is easy and inexpensive to produce.

One aspect of the invention relates to a method for producing a fiber composite component. This is meant to be understood in such a way that a fiber composite component generally has two main constituents, which is to say a matrix made of plastic material and reinforcing fibers that are introduced in the matrix. These fibers can be carbon fibers or glass fibers, for example.

According to one embodiment of the invention, the method comprises the steps: producing a filler for a preform of the fiber composite component from a plastic material, wherein the preform comprises a textile material; crosslinking (for example, chemical crosslinking or radiation crosslinking) the plastic material of the filler, so that plastic molecules of the plastic material are bonded together; inserting the filler into the preform of the fiber composite component; and bonding the filler to the preform so as to form the fiber composite component.

It is possible for the filler to be inserted into the preform prior to or after crosslinking and/or for the filler to be molded prior to or after crosslinking (it is conceivable to mechanically work the filler after irradiation).

For example, a filler having an outside geometry that is adapted to a cavity in the preform can be crosslinked, so that the material properties thereof improve, and can subsequently be inserted into the preform so as to form the fiber composite component.

According to one embodiment of the invention, the plastic material is crosslinked by irradiating the filler with radiation. For example, the filler can be irradiated with electron beam, X-ray and/or gamma radiation. This type of irradiation of plastic material with generally high-energy radiation (normally electrons or electromagnetic radiation) causes molecule chains in the plastic material (generally a polymer) to crosslink in a way that they would not in purely chemical processes. It is possible in this way to alter the material properties of the plastic material of the filler and, in particular, to adapt the filler to the function thereof in the fiber composite component.

Overall, fillers having higher chemical and/or thermal stability can be generated by the irradiation. These properties can additionally also be adapted to the requirements of the fiber composite component by adapting the radiation intensity.

It shall be understood that radiation crosslinking can also merely involve the partial crosslinking of the plastic material. However, it is also possible for the plastic material to be completely crosslinked.

For example, the mechanical properties of the filler can be altered and, for example, the elasticity thereof can be lowered and/or be adapted to the elasticity of the entire fiber composite component.

It is also possible to alter the chemical properties of the filler in such a way that the material of the filler, for example, loses the thermoplastic properties thereof and/or no longer reacts, or reacts only to a reduced degree, with the matrix material of the fiber composite component.

According to one embodiment of the invention, the plastic material of the filler is chemically crosslinked. For example, the filler can be produced from a rubber material, which is chemically crosslinked or vulcanized.

According to one embodiment of the invention, the filler is produced from a rubber material, such as EPDM rubber material. Prior to insertion into the preform, the rubber material can be partially or completely vulcanized and subsequently radiation crosslinked. A filler made of rubber material can be distinguished by the high damping properties thereof and can positively influence the impact behavior of the fiber composite component.

According to one embodiment of the invention, the preform and the filler are cast in resin to form the fiber composite component. The filler and the preform can be bonded to each other in this way. The resin or resin material can also fill in any potentially remaining intermediate spaces between the filler and the preform. The resin material can also be used to form the matrix material of a (purely) textile preform. For example, the resin material can be a duromer (such as epoxy resin or phenolic resin) or a thermoplastic resin (such as polyamide).

According to one embodiment of the invention, the filler is produced from a thermoplastic resin, such as polyetherimide. The thermoplastic resin can subsequently be crosslinked at least partially, or completely (which is to say as much as possible), by way of radiation crosslinking (electron beams, for example). Differing degrees of crosslinking allow the properties of the filler to be influenced and adapted to the specific requirements. The irradiated filler can subsequently be inserted into the preform.

According to one embodiment of the invention, reinforcement fibers, such as carbon fibers, are introduced into the filler during the production of the filler. The compressive strength of the filler can thus be increased. Moreover, the fibers allow the rigidity of the filler to be adapted better to the rigidity of the remaining constituents of the fiber composite component.

The reinforcement fibers can comprise short fibers and/or long fibers. When using thermoplastic resin as the material of the filler, the fibers can be introduced into the melt of the thermoplastic resin during the production of the filler. In the case of rubber materials, the fibers can be introduced mechanically (by kneading, for example).

According to one embodiment of the invention, the filler is irradiated with electron beam, X-ray and/or gamma radiation, for example. Radiation crosslinking is possible with various types of radiation. Thermoplastic materials can be crosslinked by way of electron beams, for example.

According to one embodiment of the invention, the filler has an elongated shape having a polygonal cross-section. For example, the cavity can be formed between a planar molded part and two (orthogonally) angled molded parts, which together can form a T-shaped reinforcement, for example. The resulting cavity can in this way have an elongated design having a triangular tent- or gusset-shaped cross-section. In corresponding fashion, the filler can also have a tent- or gusset-shaped design.

According to one embodiment of the invention, the filler is extruded. In particular, thermoplastic fillers having a constant cross-section can be produced very precisely and cost-effectively by way of extrusion. Fillers made of rubber material can also be extruded.

According to one embodiment of the invention, the filler is injection molded. Fillers having a variable cross-section, in particular those made of thermoplastic material, can be produced by way of injection molding. In addition to injection molding, fillers made of rubber material can also be shaped using calendered plates.

According to one embodiment of the invention, multiple molded parts are joined to form the preform. For example, a molded part can be planar, and one or more molded parts are applied thereto for reinforcement, for example two orthogonal molded parts, which form a T-shaped arrangement.

According to one embodiment of the invention, the filler is inserted between the molded parts during the joining of the multiple molded parts. Before the two above-mentioned orthogonal molded parts are disposed on the planar molded part, the filler can be deposited on the planar molded part at the corresponding location, for example.

According to one embodiment of the invention, the preform comprises at least one pre-impregnated molded part or prepreg molded part. For example, the filler can be inserted into a fiber composite component that has not cured yet. A prepreg molded part can be understood to mean a semi-finished product, which comprises fibers and a matrix of uncured plastic material (such as thermoset). The pre-impregnated molded parts can have been given a particular shape (such as orthogonal or L-shaped) prior to joining together the preform.

After the prepreg molded parts and the filler have been joined, and after the casting in resin material (which can be the same material as the matrix material of the prepreg molded parts), the fiber composite component can be cured by heating, for example.

According to one embodiment of the invention, the preform comprises at least one (in particular non-impregnated) textile molded part. A textile molded part can be understood to mean a molded part that is composed solely of fibers, such as a nonwoven fabric or a relatively rigid three-dimensional structure composed of fibers.

In this case, the textile molded part or parts, together with the filler, can be saturated in resin material and optionally subsequently be cured. In this way, the filler is cast in the resin material, and the matrix of the fiber composite component is formed of the resin material. Suitable resin or matrix materials can be thermoset and thermoplastic materials.

A further aspect of the invention relates to the use of a chemically crosslinked or radiation crosslinked filler for filling a cavity in a fiber composite component. As was already mentioned, the filler can be cast with a resin material in a preform of the fiber composite component.

A further aspect of the invention relates to a fiber composite component, such as the one that can be produced with the method described above and hereafter.

According to one embodiment of the invention, the fiber composite component comprises one or more molded parts having a textile material and a chemically crosslinked or radiation crosslinked filler in a cavity that is formed by the one or more molded parts. It shall be understood that the entire cavity can be filled by the filler, potentially together with the resin material.

According to one embodiment of the invention, the one or more molded parts and the crosslinked filler are cast together in a resin material. For example, the filler can be cast with the molded parts in a resin material, which also forms the matrix of the fiber composite component.

Exemplary embodiments of the invention are described hereafter in detail with reference to the accompanying figures.

### BRIEF DESCRIPTION OF THE FIGURES

FIG. 1 shows a cross-sectional view of a fiber composite component according to one embodiment of the invention; and

FIG. 2 shows a flow chart for a method for producing a fiber composite component according to one embodiment of the invention.

As a matter of principle, identical or similar parts are denoted by the same reference numerals.

### DETAILED DESCRIPTION OF EXEMPLARY EMBODIMENTS

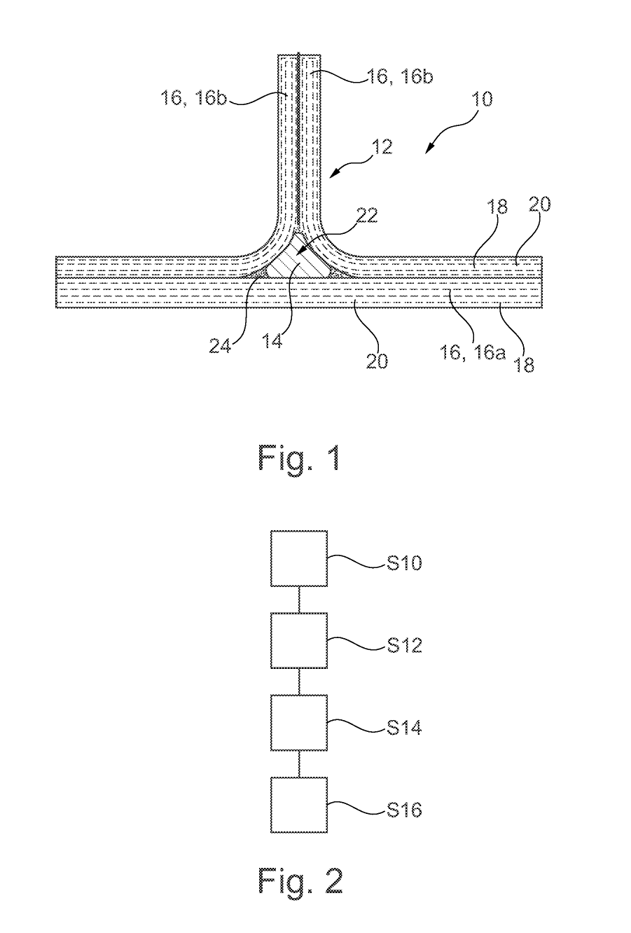

FIG. 1 shows a cross-section through a fiber composite component 10, which is composed of a preform 12 and a radiation crosslinked filler 14.

The preform 12 comprises multiple molded parts 16, as shown in FIG. 1, these being a substantially planar molded part 16a and two orthogonally bent or L-shaped molded parts 16b. The molded parts 16 can either be formed of textile molded parts, which were saturated with a matrix material, and potentially cured, after the preform 12 was assembled and/or the filler 14 was inserted. However, the molded parts 16 can also be formed of prepreg molded parts, which were cured after the preform 12 was assembled and/or the filler 14 was inserted.

In both instances, the constituents of the fiber composite component that are formed of the preform comprise a textile material 18 or fibers 18, which is or are embedded into a cured matrix material 20.

A cavity 22 is formed between the molded parts 16, which is filled completely by the filler 14 and a resin material 24, which can be identical to the matrix material 20. For example, the filler 14 can have been inserted into the preform 12 made of textile and/or prepreg molded parts 16 and subsequently have been cast in the resin material 24.

The mechanical and/or chemical properties of the filler 14 were altered by chemical crosslinking or radiation crosslinking so as to better adapt the filler to the requirements in the composite component. These altered properties are measurable and at least some of these can only be achieved by a chemical crosslinking process and/or a radiation crosslinking process. A crosslinked filler 14 can thus be clearly distinguished from an untreated filler that is made of the same untreated material.

The cavity 22 and/or the filler 14 can be elongated and/or have a uniform cross-section (in a direction perpendicular to the plane of the cross-section). For example, the cavity and/or the filler can have a polygonal cross-section, and in particular a gusset-shaped cross-section).

FIG. 2 shows a method by way of which the fiber composite component 10 from FIG. 1 can be produced.

In step S10, the filler 14 is produced from a plastic material. For example, the filler 14 can be extruded or injection molded from a thermoplastic resin. The filler can also be extruded or injection molded from a rubber material, or molded or cut from calendered plates. It is also conceivable for the filler 14 to undergo a secondary machining step after curing, for example by additional machining after the extrusion process.

In addition, reinforcement fibers can be incorporated into the filler 14. For example, the fibers can be introduced into a melt of the plastic material or kneaded into the plastic material while it is still soft.

In step S12, the plastic material of the filler 14 is radiation crosslinked by way of irradiation, or crosslinked using a chemical process, so that plastic molecules of the plastic material bond together. In general, the filler 14 can be irradiated with beta, X-ray and/or gamma radiation. Using so-called electron beam radiation, it is possible, for example, to alter the chemical and mechanical properties of polymers, for example, such as polyethylene, polypropylene and the like.

In step S14, the molded parts 16 are joined to form the preform 12 and, at the same time, the filler 14 is inserted into the preform 12. Prepreg molded parts 16 and/or purely textile molded parts 16, for example, can be joined to form the pre-form 12, wherein the filler 14 is received between the molded parts 16.

In step S16, the filler 14 is bonded to the preform 12. If the preform 12 comprises prepreg molded parts 16, for example, the filler 14 can be cast in a resin material 24, and subsequently the matrix material of the prepreg molded parts 16 and/or the resin material 24 can be cured. If the preform 12 comprises textile molded parts 16, the resin material 24 can also be used as the matrix material 20 for the textile molded parts 16, which can also be saturated with the resin material 24. In this case, the resin material 24 can be cured (by using heat, for example).

In addition, it shall be pointed out that “comprising” does not exclude other components or steps, and that “a” or “an” does not exclude the plural form. It shall furthermore be pointed out that features or steps that were described with reference to one of the above exemplary embodiments can also be used in combination with other features or steps of other exemplary embodiments described above. Reference numerals in the claims shall not be interpreted to have a limiting effect.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a fiber composite component, comprising the steps:
producing a filler for a preform of the fiber composite component from a plastic material, wherein the preform comprises a textile material;
crosslinking the plastic material of the filler, so that plastic molecules of the plastic material are bonded together;
inserting the filler into the preform of the fiber composite component; and
bonding the filler to the preform so as to form the fiber composite component.

2. The method of claim 1, wherein
the plastic material is crosslinked by irradiating the filler with radiation; or
the filler is irradiated with electron beam, X-ray, or gamma radiation.

3. The method of claim 1, wherein the plastic material of the filler is chemically crosslinked.

4. The method of claim 1, wherein the preform and the filler are cast in resin material so as to form the fiber composite component.

5. The method of claim 1, wherein the filler is produced from
a thermoplastic resin; or
a rubber material.

6. The method of claim 1, wherein reinforcement fibers are introduced into the filler during the production of the filler.

7. The method of claim 1, wherein the filler has an elongated shape having a polygonal cross-section.

8. The method of claim 1, wherein the filler is
extruded; or
injection molded.

9. The method of claim 1, wherein multiple molded parts are joined to form the preform.

10. The method of claim 9, wherein the filler is introduced between the molded parts during the joining of the multiple molded parts.

11. The method of claim 1, wherein the preform comprises at least one pre-impregnated molded part.

12. The method of claim 1, wherein the preform comprises at least one non-impregnated textile molded part.

13. A fiber composite component, comprising:
one or more molded parts having a textile material; and
a chemically crosslinked or radiation crosslinked filler in a cavity that is formed by the one or more molded parts.

14. The fiber composite component of claim 13, wherein the one or more molded parts and the radiation crosslinked filler are cast together in a resin material.
